(19) United States
(12) Patent Application Publication
(10) Pub. No.: US 2017/0159394 A1
(43) Pub. Date: Jun. 8, 2017

(54) Proportional Electrohydraulic Servo Valve Closed Loop Feedback Control of Pressure Reducing and Relieving Hydraulic Circuit

(71) Applicant: Hydril USA Distribution LLC, Houston, TX (US)

(72) Inventor: Christopher Lance Kalinec, Houston, TX (US)

(73) Assignee: Hydril USA Distribution LLC, Houston, TX (US)

(21) Appl. No.: 14/956,941

(22) Filed: Dec. 2, 2015

(51) Int. Cl. E21B 33/064; F16K 31/42; G05B 19/416; E21B 33/06

(52) U.S. Cl. CPC E21B 33/064; E21B 33/063; F16K 31/42; G05B 19/416; G05B 2219/37371

(57) ABSTRACT

Systems, devices and methods for regulating pressure in a blowout preventer (BOP) of a subsea well assembly. A closed loop regulator (CLR) that combines the functions of a pressure relieving valve and a pressure reducing valve into one body to control the pressure of a hydraulic circuit or a BOP mux control pod. A closed loop servo valve controlled proportional electrohydraulic reducing valve is used to allow continual variation of the pressure set point for the downstream circuit. If the downstream pressure exceeds the set point by a predetermined amount, the pressure relieving valve vents the pressure to the reservoir or atmosphere.

### BACKGROUND OF THE INVENTION

1. Field

The field of invention relates generally to blowout preventer (BOP) equipment for use in oil and gas production, and specifically to BOP multiplexer (MUX) control systems.

2. Description of the Related Art

BOP systems are hydraulic systems, used to prevent blowouts from subsea oil and gas wells. BOP equipment typically includes a set of two or more redundant control systems with separate hydraulic pathways to operate a specified BOP function. The redundant control systems are commonly referred to as blue and yellow control pods. In known systems, a communications and power cable sends information and electrical power to an actuator with a specific address. The actuator in turn moves a hydraulic valve, thereby opening fluid to a series of other valves/piping to control a portion of the BOP. However, present BOP regulators exhibit instability and subsequent pressure spikes.

### SUMMARY

As disclosed, the present invention includes systems, devices and methods for regulating pressure in a blowout preventer (BOP) of a subsea well assembly. The systems and devices include a closed loop regulator (CLR) that combines the functions of a pressure relieving valve and a pressure reducing valve into one body to control the pressure of a hydraulic circuit, for example, a BOP mux control pod. A closed loop servo valve controlled proportional electrohydraulic reducing valve is used to allow continual variation of the pressure set point for the downstream circuit. If the downstream pressure exceeds the set point by some configurable amount, the pressure relieving valve vents the pressure to the reservoir or atmosphere. The functionality of the CLR includes a closed loop feedback control of the pressure set point, and therefore eliminates the instability and subsequent pressure spikes seen with the present regulators.

One example embodiment is a control system for controlling pressure of a hydraulic circuit in a subsea well assembly. The control system includes a pilot servo valve hydraulically connected in series with a pressure reducing valve, a pressure transducer configured to measure output pressure of the pressure reducing valve, a control device functionally coupled to the pressure transducer, the control device configured to read the output pressure measurement from the pressure transducer, and a pressure relieving valve functionally coupled with the control device, wherein the control device is further configured to determine that the output pressure measurement is greater than a predetermined value, and cause to transmit a command signal to the pressure relieving valve; wherein the pressure relieving valve relieves at least a portion of the pressure upon receiving the command signal.

One example embodiment is a control method for controlling pressure of a hydraulic circuit in a subsea well assembly. The control method includes measuring, by a pressure transducer, output pressure of a pressure reducing valve, reading, by a control device, the measurement from the pressure transducer, determining, by the control device, that the measurement is greater than a predetermined value, causing to transmit, by the control device, a command signal to a pressure relieving valve, and relieving at least a portion of the pressure by the pressure relieving valve, thereby reducing pressure to under the predetermined value.

One example embodiment is a non-transitory computer-readable medium having computer executable instructions that when executed cause a control device in a subsea well assembly to perform the operations of reading, from a pressure transducer, a measurement of output pressure of a pressure reducing valve in a hydraulic circuit, determining that the measurement is greater than a predetermined value, causing to transmit a command signal to a pressure relieving valve, and causing to relieve at least a portion of the pressure by the pressure relieving valve, thereby reducing pressure to under the predetermined value.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a representative system overview of a BOP stack.

FIG. 2 is a representative diagram of a decentralized sub-pod system according to one or more example embodiments of the present disclosure.

FIG. 3 is a schematic of a control system for controlling pressure of a hydraulic circuit in a subsea well assembly, according to one or more example embodiments of the present disclosure.

FIG. 4 is a schematic of a control system for controlling pressure of a hydraulic circuit in a subsea well assembly, according to one or more example embodiments of the present disclosure.

FIG. 5 is a block diagram of a control device according to one or more example embodiments of the present disclosure.

FIG. 6 is a flow chart according to one or more example embodiments of the present disclosure.

### DETAILED DESCRIPTION

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “couple” and its conjugated forms means to complete any type of required junction, including electrical, mechanical or fluid, to form a singular object from two or more previously non-joined objects. If a first device couples to a second device, the connection can occur either directly or through a common connector. “Optionally” and its various forms means that the subsequently described event or circumstance may or may not occur. The description includes instances where the event or circumstance occurs and instances where it does not occur.

The present invention relates to control systems and related methods for components of a subsea blow-out preventer (BOP). Typically, such control systems are hydraulic systems, and include a set of two or more redundant control systems with separate hydraulic pathways to operate a specified BOP function. The redundant control systems are commonly referred to as blue and yellow control pods. In known systems, a communications and power cable sends information and electrical power to an actuator with a specific address. The actuator in turn moves a hydraulic valve, thereby opening fluid to a series of other valves/piping to control a portion of the BOP and/or the BOP supporting equipment.

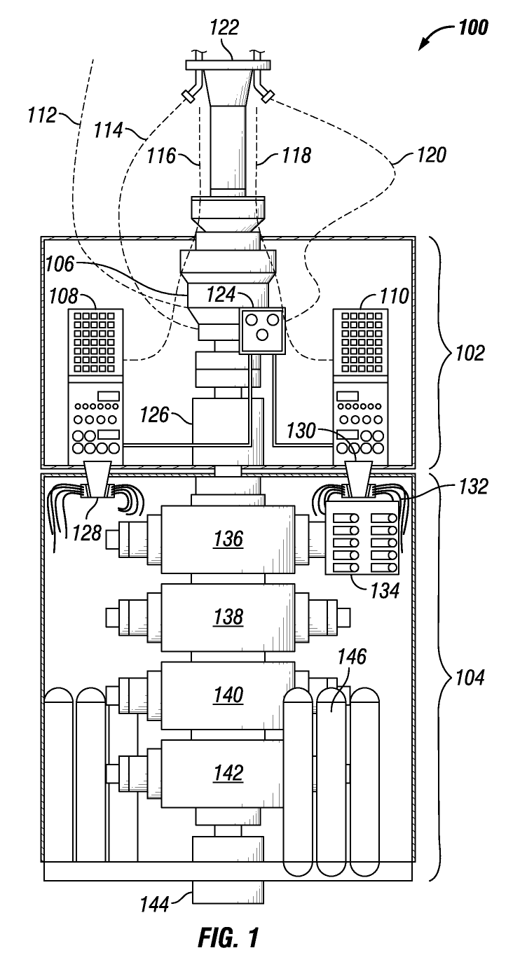

Referring first to FIG. 1, a representative system overview of a BOP stack 100 is shown. BOP stack 100 includes a lower marine riser package (LMRP) 102 and a lower BOP stack 104. LMRP 102 includes an annular 106, a blue control pod 108, and a yellow control pod 110. A hotline 112, a blue conduit 114, and a yellow conduit 120 proceed downwardly from a riser 122 into LMRP 102 and through a conduit manifold 124 to control pods 108, 110. A blue power and communications line 116 and a yellow power and communications line 118 proceed to control pods 108, 110, respectively. An LMRP connector 126 connects LMRP 102 to lower BOP stack 104. Hydraulically activated wedges 128 and 130 are disposed to suspend connectable hoses or pipes 132, which can be connected to shuttle panels, such as shuttle panel 134.

Lower BOP stack 104 includes shuttle panel 134, and further includes a blind shear ram BOP 138, a casing shear ram BOP 136, a first pipe ram 140, and a second pipe ram 142. BOP stack 100 is disposed above a wellhead connection 144. Lower BOP stack 104 further includes optional stack-mounted accumulators 146 containing a necessary amount of hydraulic fluid to operate certain functions within BOP stack 100.

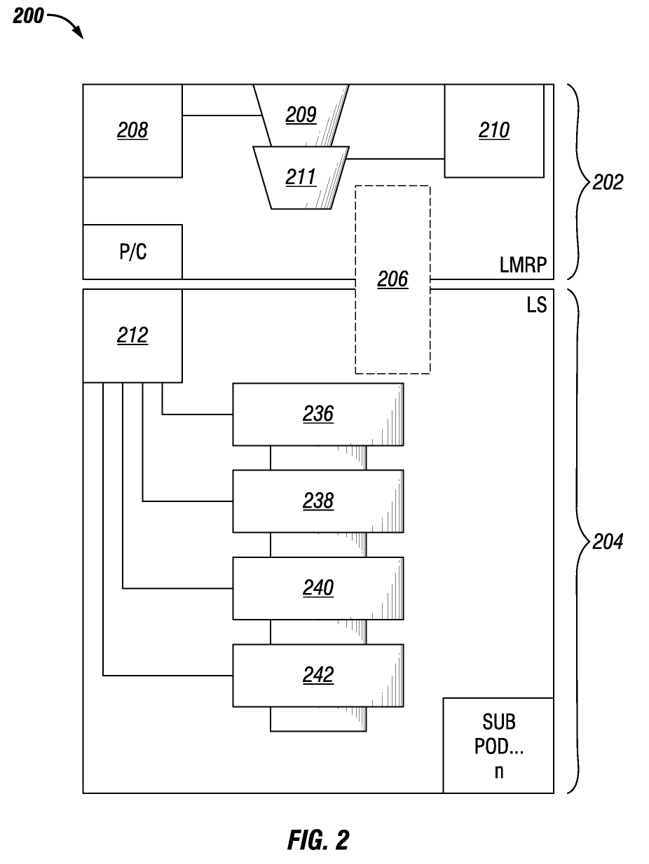

Referring now to FIG. 2, a representative diagram of a decentralized sub-pod system is shown. Sub-pod system 200 has an LMRP portion 202 and a lower BOP stack portion 204. A coupling 206 proceeds between LMRP portion 202 and lower BOP stack portion 204. Coupling 206 can include any one of or any combination of electric communication connections, power connections, and hydraulic connections. LMRP portion 202 includes a first sub-pod 208 and a second sub-pod 210. More or fewer sub-pods can be disposed within LMRP portion 202. Sup-pods 208, 210 can replace components of a single pod, such as, for example, blue control pod 108 or yellow control pod 110 of FIG. 1. Sup-pod 208 is operably coupled to annular BOP 209, and sub-pod 210 is operably coupled to annular BOP 211. Sup-pod 208 controls operation of annular BOP 209, and sup-pod 210 is used to control annular BOP 211.

Lower BOP stack portion 204 includes a sub-pod 212. Sub-pod 212 is in fluid communication with a casing shear ram BOP 236, a blind shear ram BOP 238, a first pipe ram 240, and a second pipe ram 242. More or fewer sub-pods and/or rams can be disposed within lower stack portion 204. Sub-pods 208, 210, and 212 can be controlled by centrally-located remote controls, such as, for example, a personal computer. Sub-pods 208, 210, and 212 advantageously decentralize a single control pod, such that the failure of any one component does not require the replacement of all components. For instance, Sub-pods 208, 210, and 212 are independently retrievable by a remotely operated vehicle (ROV), or similar means, and are independently replaceable and repairable, without replacing all of the sub-pods.

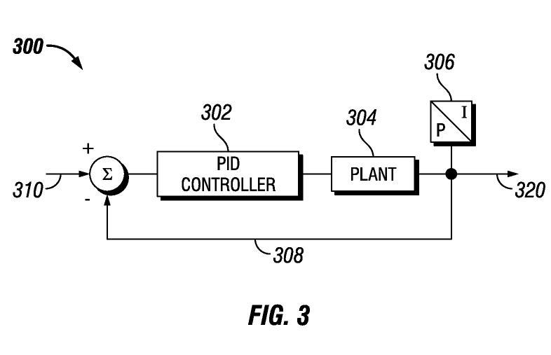

In the embodiment of FIG. 2, sub-pods 208, 210, 212 individually communicate with a central subsea electronics module, or SEM (not pictured), which in turn communicates with a user on the surface. Electrical connections can be wireless, wet-mate, or hard-wired to the surface. The power/communications (P/C) module in FIG. 2 receives instructions from the user on the surface, or other auxiliary inputs (e.g. an ROV), and via a chosen communications protocol (such as described below with regard to FIG. 3) instructs the appropriate sub-pod's controller, such as controller 302 shown in FIG. 3, to execute a commanded function. A controller, such as controller 302 shown in FIG. 3, translates the instructions into discrete output signals that will power a solenoid or other energy transducer required for the requested function. A sub-pod controller will also determine the required pressure for the requested function (e.g. blind-shear ram (BSR) close, annular BOP close, etc.), and send the appropriate output signal to a closed-loop controlled regulator, such as an electro-hydraulic closed-loop controlled regulator 300.

Sub-pods 208, 210, and 212 include modular valve packs that can be scaled as required. They are located as required to minimize plumbing and/or achieve other layout goals within LMRP portion 202 and lower stack portion 204. Any number of sub-pods can be used in either LMRP portion 202 or lower stack portion 204 as is required for a number of customer functions and/or required redundancy. Sub-pods 208, 210, and 212 include common connection interfaces for hydraulics, electrical power, and communications.

For a new BOP stack, plumbing can be customized to suit the layout of the BOP stack with one or more sub-pods. In other words, a sub-pod would be placed where it optimally suits the individual BOP stack layout. For a retrofit of an existing BOP stack, the plumbing might be new from the sub-pods up to the shuttle valves, such as shuttle panel 134 in FIG. 1, but from there the existing plumbing in the BOP stack would be used.

Referring now to FIG. 3, illustrated is a control system 300 for controlling pressure of a hydraulic circuit or plant 304 in a subsea well assembly, according to one or more example embodiments of the present disclosure. Control system 300 includes one or more pressure transducers 306 that can measure the pressure at output 320 of the hydraulic circuit or plant 304. The pressure reading from the pressure transducers 306 is fed back to a controller 302 via feedback control line 308 in combination with a command signal 310. Controller 302 may regulate the pressure in the plant 304 using pressure readings from pressure transducers 306 in real-time.

Controller 302 may include a proportional-integral-derivative (PID) controller, which may include a control loop feedback controller. Alternatively or in addition, the PID controller may include a control device, such as a microcontroller or microprocessor, or simply a programmable controller. The PID controller 302 may continuously calculate an “error value” as the difference between the measured pressure and a desired set-point. The controller 302 may attempt to minimize the error over time by adjustment of a control variable, such as the fluid pressure, to a new value determined by a weighted sum according to the following formula:

$$u ( t ) = {K}_{p} e ( t ) + {K}_{i} {\int }_{0}^{t} e ( τ ) d τ + {K}_{d} \frac{d e}{d t}$$

where Kₚ, Kᵢ, and K_{d}, all non-negative, denote the coefficients for the proportional, integral, and derivative terms, respectively. In this model, the first component is the proportional component, which accounts for present values of the error. For example, if the error is large and positive, the proportional control will also be large and positive. Similarly, the second component is the integral component, which accounts for past values of the error. For example, if the output is not sufficient to reduce the size of the error, error will accumulate over time, causing the integral component to apply stronger output. Finally, the third component is the derivative component, which accounts for predicted future values of the error, based on its current rate of change.

The response of the controller 302 can be described in terms of the responsiveness of the controller to an error, the degree to which the controller overshoots the set-point, and the degree of system oscillation. The proportional term produces an output value that is proportional to the current error value. The proportional response can be adjusted by multiplying the error by a constant Kₚ, called the proportional gain constant. The proportional term is given by:

Pₒᵤᵣ=Kₚe(t)

A high proportional gain results in a large change in the output for a given change in the error. In contrast, a small gain results in a small output response to a large input error, and a less responsive or less sensitive controller. If the proportional gain is too low, the control action may be too small when responding to system disturbances.

The contribution from the integral term is proportional to both the magnitude of the error and the duration of the error. The integral in the PID controller is the sum of the instantaneous error over time and gives the accumulated offset that should have been corrected previously. The accumulated error is then multiplied by the integral gain (Kᵢ) and added to the controller output. The integral term is given by:

Iₒᵤₜ=Kᵢ∫₀^{t}e(T)dT

The integral term accelerates the movement of the process towards set-point and eliminates the residual steady-state error that occurs with a pure proportional controller.

The derivative of the process error is calculated by determining the slope of the error over time and multiplying this rate of change by the derivative gain K_{d}. The magnitude of the contribution of the derivative term to the overall control action is termed the derivative gain, K_{d}. The derivative term is given by:

$${D}_{out} = {K}_{d} \frac{d }{d t} e ( t )$$

Derivative action predicts system behavior and thus improves settling time and stability of the system 300.

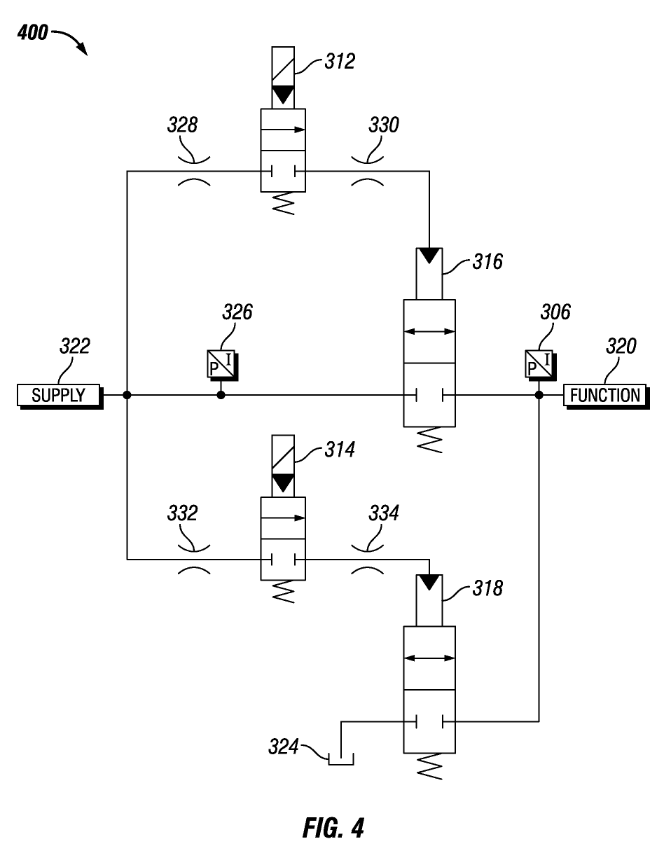

Turning now to FIG. 4, illustrated is a schematic of a closed loop regulator (CLR) 400 according to one or more example embodiments of the present disclosure. CLR 400 may have a supply 322, for example 5000 psi, and a controlled output 320, for example 3000 psi. CLR 400 may include one or more pilot valves 312, 314, one or more pressure reducing valves 316, and one or more pressure relieving valves 318. CLR 400 may also include one or more pressure transducers 306, 326 for measuring pressure at one or more points in the system. Orifices 328, 330, 332, and 334 may be used to control flowrates and thus response times of the valves 312, 314.

CLR 400 combines the functions of a pressure relieving valve 318 and a pressure reducing valve 316 into one body to control the pressure of a hydraulic circuit, for example a BOP mux control pod. The controlled proportional electrohydraulic reducing valve 316 is used to allow continual variation of the pressure set-point for the downstream circuit. If the downstream pressure exceeds the set-point by a predetermined amount, the pressure relieving valve 318 vents the pressure to the reservoir or atmosphere 324. Pressure relieving valve 318 may be hydraulically grounded where the tank or reservoir 324 is at atmospheric pressure. The functionality of the CLR 400 eliminates the instability and subsequent pressure spikes seen with the present BOP regulators.

The closed loop servo valves 316, 318 and the pressure transducers 306, 326 may be located in a pressure compensated area with a dielectric fluid. The dielectric fluid may include an oil-based dielectric fluid and the working fluid may include 95% water and 5% glycol, for example. The closed loop servo valves may include a 2-stage servo valve with spool and bushing and a dry torque motor or a proportional solenoid. The system may also include a 2-way spool type pressure reducing valve. The 2-way pressure reducing valve may be used to reduce a variable input pressure to a lower constant output pressure. Wet-mate or dry-mate connectors may be used for connecting the servo valve and the pressure transducers. The closed loop servo valve may have an operating pressure of 0-350 bars or 0-5000 psi, and a maximum flow rate of 380 lpm or 100 gpm.

The pilot valves 312, 314 may include a hydraulic analog servo valve including a pressure compensated cover with a dielectric fluid or a digital servo valve including one atmosphere nitrogen filled containers. The dielectric fluid may include an oil-based dielectric fluid and the working fluid may include 95% water and 5% glycol, for example. The pilot valves may have an operating pressure of 0-350 bars or 0-5000 psi, and a maximum flow rate of 380 lpm or 100 gpm.

The present technology reduces or eliminates problems associated with water hammer. Water hammer is associated with pilot stage plumbing issues, regulator chatter, and instability. Elimination of these problems can be accomplished by replacing current regulators with closed-loop, controlled, electro-hydraulic mechanisms, such as electro-hydraulic closed-loop controlled regulator 400, located at each control pod.

Control Device and Computer Readable Medium

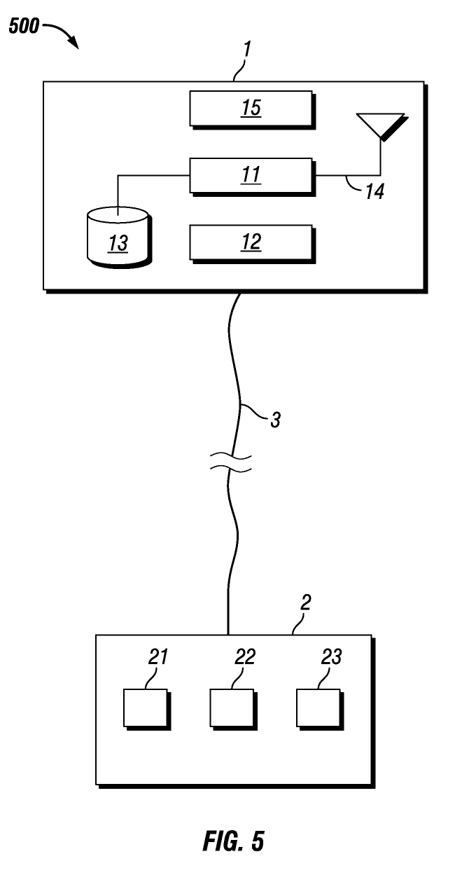

FIG. 5 is a block diagram of a control system 500 according to an embodiment of the invention. The control system includes a control device 1 connected to a deployed BOP 2 via an undersea electrical connection 3. The BOP 2 includes at least one of a group of solenoid valves 21, a group of flow meters 22 and a group of transducers 23. The control device includes a processor 11, an interface device 12 that connects the processor to the undersea electrical connection 3, a memory 13 that stores one or more BOP device profiles, a wireless communication device 14, and a display panel 15.

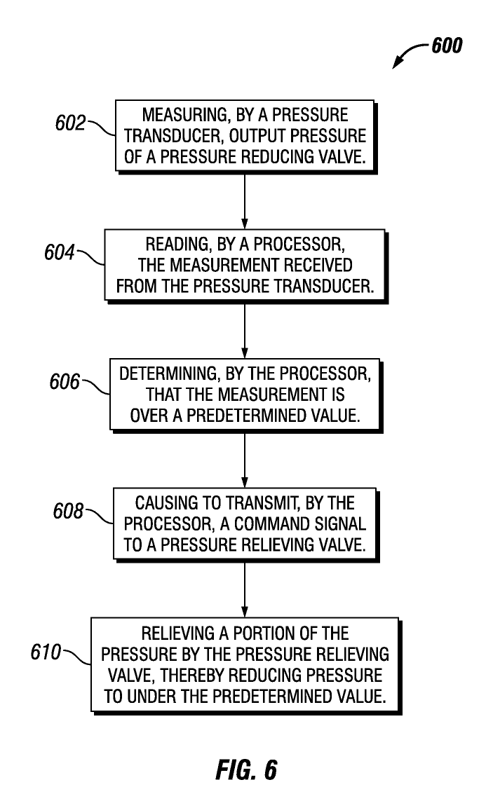

As shown in FIG. 6, the disclosed exemplary embodiments provide a system and a method for controlling pressure in a subsea well in general, and BOP control pods in particular, by a control device. The method 600 includes, at operation 602, measuring, by a pressure transducer, output pressure of a pressure reducing valve. The method also includes, at operation 604, reading, by a processor or controller, the measurement from the pressure transducer. The method also includes, at operation 606, determining, by the processor or controller, that the measurement is greater than a predetermined value. The method also includes, at operation 608, causing to transmit, by the processor or controller, a command signal to a pressure relieving valve. The method also includes, at operation 610, relieving a portion of the pressure by the pressure relieving valve, thereby reducing pressure to under the predetermined value.

According to still another exemplary embodiment, there is a non-transitory computer readable medium, such as memory 13, containing instructions configured to cause control device 1 to execute the method described above.

In another example embodiment, the invention relates to computer programs stored in computer readable media, such as memory 13. Referring to FIG. 5, the foregoing process as explained with reference to FIG. 6 can be embodied in computer-readable code. The code can be stored on, e.g., a computer readable medium in the form of volatile memory, such as random access memory (RAM), and/or non-volatile memory, such as read only memory (ROM). The example computational environment shown in FIG. 5 is only illustrative and is not intended to suggest or otherwise convey any limitation as to the scope of use or functionality of such computational environments' architecture. In addition, the computational environment should not be interpreted as having any dependency or requirement relating to any one or combination of components illustrated in this example computational environment. The computational environment represents an example of a software implementation of the various aspects or features of the disclosure in which the processing or execution of operations described in connection with performing a maintenance action in accordance with this disclosure, can be performed in response to execution of one or more software components at the computing device. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device or functionally coupled thereto.

The control device 1 can operate in a networked environment by utilizing connections to one or more remote computing devices. As an illustration, a remote computing device can be a personal computer, a portable computer, a server, a router, a network computer, a peer device or other common network node, and so on. As described herein, connections (physical and/or logical) between the control device 1 and a computing device of the one or more remote computing devices can be made via one or more traffic and signaling pipes, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

It should be appreciated that while the control device 1 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs), a programmable logic controller (PLC), a complex programmable logic device (CPLD), a discrete gate or transistor logic, discrete hardware components, and combinations of various hardware and logic circuitry for performing at least the functions described herein. In certain embodiments, the functional elements may refer to one or more processes operating or otherwise executing on one or more processors. It should further be appreciated that portions of the control device 1 can embody or can constitute an apparatus. For instance, the processing circuitry 150 and the memory 160 can embody or can constitute an apparatus that can operate in accordance with one or more aspects of this disclosure.

For purposes of simplicity of explanation, the example method disclosed herein is presented and described as a series of blocks (with each block representing an action or an operation in a method, for example). However, it is to be understood and appreciated that the disclosed method is not limited by the order of blocks and associated actions or operations, as some blocks may occur in different orders and/or concurrently with other blocks from those that are shown and described herein. For example, the various methods (or processes or techniques) in accordance with this disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The system and method described herein, therefore, are well adapted to carry out the objects and attain the ends and advantages mentioned, as well as others inherent therein. While example embodiments of the system and method has been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

What is claimed is:

1. A control system for controlling pressure of a hydraulic circuit in a subsea well assembly, the system comprising:
a pilot servo valve hydraulically connected in series with a pressure reducing valve;
a pressure transducer configured to measure output pressure of the pressure reducing valve;
a control device functionally coupled to the pressure transducer and configured to read the output pressure measurement from the pressure transducer; and
a pressure relieving valve functionally coupled with the control device;
wherein the control device is further configured to:
determine that the output pressure measurement is greater than a predetermined value; and
cause to transmit a command signal to the pressure relieving valve;
wherein the pressure relieving valve relieves at least a portion of the pressure upon receiving the command signal.

2. The system of claim 1, wherein the hydraulic circuit comprises a blowout preventer (BOP) multiplexer (MUX) control pod.

3. The system of claim 1, wherein the control device comprises a proportional-integral-derivative (PID) controller.

4. The system of claim 1, further comprising one or more orifices to control flowrates and response times of the pilot servo valve.

5. The system of claim 1, wherein the servo valve and the pressure transducer are located in a pressure compensated area with a dielectric fluid.

6. The system of claim 5, wherein a working fluid in the pilot servo valve comprises 95% water and 5% glycol.

7. The system of claim 1, wherein the servo valve comprises a 2-stage servo valve with spool and bushing and a dry torque motor or a proportional solenoid.

8. The system of claim 1, wherein the pressure reducing valve comprises a 2-way spool type pressure reducing valve.

9. The system of claim 1, further comprising a wet-mate or dry-mate connector connecting the servo valve and the pressure transducer.

10. The system of claim 1, wherein the servo valve comprises a hydraulic analog servo valve including a pressure compensated cover with a dielectric fluid or a digital servo valve including a one atmosphere nitrogen filled container.

11. A control method for controlling pressure of a hydraulic circuit in a subsea well assembly, the method comprising:
measuring, by a pressure transducer, output pressure of a pressure reducing valve;
reading, by a control device, the measurement from the pressure transducer;
determining, by the control device, that the measurement is greater than a predetermined value;
causing to transmit, by the control device, a command signal to a pressure relieving valve; and
relieving, by the pressure relieving valve, at least a portion of the pressure,.

12. The method of claim 11, wherein the hydraulic circuit comprises a blowout preventer (BOP) multiplexer (MUX) control pod.

13. The method of claim 11, wherein the control device comprises a proportional-integral-derivative (PID) controller.

14. The method of claim 11, further comprising: installing one or more orifices to control flowrates and response times of the pressure reducing valve.

15. The method of claim 11, further comprising: disposing the pressure reducing valve and the pressure transducer in a pressure compensated area comprising a dielectric fluid.

16. The method of claim 11, further comprising: connecting the pressure reducing and the pressure transducer using a wet-mate or dry-mate connector.

17. The method of claim 11, further comprising: installing a hydraulic analog servo valve including a pressure compensated cover with a dielectric fluid or a digital servo valve including a one atmosphere nitrogen filled container.

18. A non-transitory computer-readable medium having computer executable instructions that when executed cause a control device in a subsea well assembly to perform the operations of:
reading, from a pressure transducer, a measurement of output pressure of a pressure reducing valve in a hydraulic circuit;
determining that the measurement is greater than a predetermined value; and
causing to transmit a command signal to a pressure relieving valve to relieve at least a portion of the pressure.

19. The non-transitory computer-readable medium of claim 18, wherein the hydraulic circuit comprises a blowout preventer (BOP) multiplexer (MUX) control pod.

20. The non-transitory computer-readable medium of claim 18, wherein the control device comprises a proportional-integral-derivative (PID) controller.
